(19) United States
(12) Patent Application Publication
(10) Pub. No.: US 2019/0072459 A1
(43) Pub. Date: Mar. 7, 2019

(54) METHOD FOR DIAGNOSING FAULT OF FACILITIES USING VIBRATION CHARACTERISTIC

(71) Applicant: Sun Hwi LEE, Suwon-si (KR)

(72) Inventor: Sun Hwi LEE, Suwon-si (KR)

(21) Appl. No.: 16/183,919

(22) Filed: Nov. 8, 2018

Related U.S. Application Data
(63) Continuation of application No. 15/038,425, filed on May 20, 2016, now abandoned.

(51) Int. Cl. G01M 13/04; G01M 5/00; G01M 7/00

(52) U.S. Cl. CPC G01M 13/045; G01M 7/00; G01M 5/0083; G01M 5/0033

(57) ABSTRACT

The present invention relates to a facility fault diagnosing method using a vibration characteristic, which comprises the steps of: dividing a vibration generated according to a fault of a facility into a plurality of vibration characteristics, configuring detailed vibration code items by subdividing the vibration characteristics, and associating and databasing the detailed vibration code items for each fault type to store the detailed vibration code items; receiving an input of a detailed vibration code item selection signal for the each vibration characteristic from a user; and determining a fault type of a facility on the basis of the each input detailed vibration code item and association information between the fault type and the detailed vibration code items. According to the present invention, a vibration fault is diagnosed through a combination of a plurality of detailed vibration components by breaking a scheme of diagnosing the vibration fault using only one vibration component so that a more reliable facility fault diagnosis can be performed.

### TECHNICAL FIELD

The present invention relates to a method for diagnosing fault of a facilities using a vibration characteristic, and in particular to a method for diagnosing fault of a facilities using a vibration characteristic which is able to allow to more accurately diagnose any vibration fault of a facility in such a way to classify a variety of vibration components which occur due to the fault of a facility and extract a vibration fault characteristic of an actual facility in combination with the classified vibration components.

### BACKGROUND ART

All the functions of a machine should be preferably operated in normal states. As time passes, machine components are inevitably degraded due to, for example, an abrasion. For this reason, faults may occur due to mechanical and thermal stresses which are caused during operations. If operations continue in the aforementioned state, a critical fault may be accompanied. A facility operator may need a facility diagnosing method, by which any fault can be previously prevented by preparing a predetermined measure to prevent a machine apparatus from having a critical fault in such a way to previously check any fault at a facility.

The machine apparatus, in general, tends to show an inherent symptom related with any fault as it is degraded. As exemplary symptoms, there are vibration, heat, noise, etc. A vibration change among such symptoms may well show a facility state, so it is used a lot as a parameter to diagnose any fault at a facility.

The aforementioned vibration may have a quick change in terms of its pattern as soon as a predetermined fault or an abnormal state occurs at a facility. It has a good response characteristic to any fault. Since the vibration ordinarily occurs during the operation of a facility, it can well show what an actual problem is, and may have a lot of information on the fault. For this reason, it is being currently used as an important parameter to detect any fault at a facility.

It, therefore, needs to recognize the kind of a fault which occurs at a machine and a vibration characteristic which coincides with the fault, and then actually measure the vibration of a machine which is in operation and analyze the measured vibration.

The conventional technology for diagnosing any fault using a vibration characteristic is described in the Korean patent registration No. 21129466 and the Korean patent laid-open No. 2007-0037667.

The Korean patent registration No. 21129466 describes that a signal inputted from a sensor, for example, an acceleration meter, etc. installed at a rotational machine is measured, and a threshold value is calculated using a wavelet coefficient transformed from the measured vibration signal, and the state of a related machine is diagnosed using the calculated threshold value.

The Korean patent laid-open No. 2007-0037667 describes a simulation apparatus configured to analyze a cause of an abnormal behavior characteristic in a rotational device and a result of the operation thereof, wherein an abnormal phenomenon is artificially caused in such a way to adjust the tension of an eccentricity guide circular plate or a belt, and then a behavior characteristic of a rotational movement and an abnormal vibration characteristic are compared.

In case where a vibration problem occurs at a facility, it may occur due to a variety of combined causes. The aforementioned conventional technologies, however, are simply directed to an abnormal state diagnosis technology using a single sensor, while failing to describe a combined abnormal state diagnosis technology wherein various vibration causes are considered.

### DISCLOSURE OF INVENTION

The conventional technologies are configured to detect only an abnormal state in vibration, wherein it is impossible to specifically check which part has a fault in the system. More specifically, the level of a fault may be evaluated by recognizing the magnitude of amplitude of a defective frequency. Even though fault symptoms are various, the components of vibration frequencies may be expressed to be identical. The conventional technology has a problem in the way that it is impossible to find out an accurate fault cause since various faults showing the same vibration characteristics cannot be correctly classified out.

The method for diagnosing fault of a facilities using a vibration characteristic according to the present invention invented to resolve the aforementioned problems is provided, wherein vibration characteristics are classified, and a detailed vibration code item is selected, and a priority sequence is assigned with respect to each detailed vibration code item which are sorted out by the type of each fault type, whereupon a vibration fault type can be determined based on a combination of the vibration code items detected at an actual equipment.

Moreover, the present invention may provide a method for diagnosing fault of a facilities using a vibration characteristic, wherein the vibration components of the facility detected from an actual equipment are matched with the detailed vibration code items sorted out by vibration characteristic, and the vibration states of the facility detected based on the set priority sequence are scored, and the types of the vibration faults are determined in the ranking of evaluation scores, and the determined rankings are provided to a user.

To achieve the aforementioned objects, there is provided a method for diagnosing fault of a facilities using a vibration characteristic, which may include, but is not limited to, a step wherein the vibrations occurring due to fault of a facilities are classified into a plurality of vibration characteristics, and the vibration characteristics are classified in detail, thus setting detailed vibration code items, and the detailed vibration code items are related for each fault item and are stored in a database; a step wherein a detailed vibration code item selection signal is received for each vibration characteristic from a user; and a step wherein a fault type of the facility is determined based on a related information between each inputted detailed vibration code item, the fault type and the detailed vibration code item.

The vibration characteristic information include two or more of a main vibration component, a secondary vibration component, a vibration direction, a time waveform, a sideband component, a phase characteristic, a load characteristic and a facility characteristic.

In the step wherein the database is constructed by relating the detailed vibration code item with each fault type, a priority sequence is assigned for each detailed vibration code item based on the extent where the vibration fault is affected for each fault type, and scores are differentiated based on the priority sequence.

In the step wherein the vibration fault types are databased, a priority sequence is assigned for each vibration characteristic information based on the extent where the vibration fault is affected for each vibration fault type, and scores are differentiated based on the priority sequence.

In the step wherein the fault type of the facility is determined, a vibration fault evaluation score is calculated based on an information on which at least one or more of a priority sequence with respect to a detailed vibration code item selected by a user for each vibration fault type set in the database or a priority sequence for each vibration characteristic information has been reflected, and a vibration fault type is determined based on the calculated vibration fault evaluation score.

If the vibration evaluation scores for each vibration fault type are same, a weight is assigned to a vibration fault type having more detailed vibration code items set in the top priority sequence for each vibration fault type among the detailed vibration code items selected by the user, and the vibration types having the same vibration evaluation scores are differentiated.

The sequence-based vibration fault types prepared up to the previously set ranking are provided for the user to confirm.

### Advantageous Effects of the Invention

The present invention is advantageous in the way that a more reliable facility fault diagnosis can be carried out in such a way to diagnose any vibration fault based on a combination of a plurality of vibration components, while overcoming the problems encountered in a conventional method wherein any vibration fault was diagnosed using only one vibration component.

Moreover, it is advantageous in the present invention that a plurality of evaluation scores are calculated in sequence based on a combination of vibration components, and a vibration fault type corresponding to the scores evaluated by sequence is extracted, whereby various vibration faults of a facility can be concurrently diagnosed.

### BRIEF DESCRIPTION OF DRAWINGS

FIG. 1 is a flow chart for describing a method for diagnosing fault of a facilities using a vibration characteristic according to the present invention.

FIG. 2 is a view illustrating an exemplary screen for describing a method for diagnosing fault of a facilities using a vibration characteristic according to the present invention.

FIG. 3 is a flow chart for describing a method for combining detailed vibration code items in a method for diagnosing fault of a facilities using a vibration characteristic according to the present invention.

FIG. 4 is a view illustrating a screen which shows a result of a facility fault diagnosis which has been carried out using a vibration characteristic according to the present invention.

### MODES FOR CARRYING OUT THE INVENTION

The preferred embodiments of the present invention will be described with reference to the accompanying drawings.

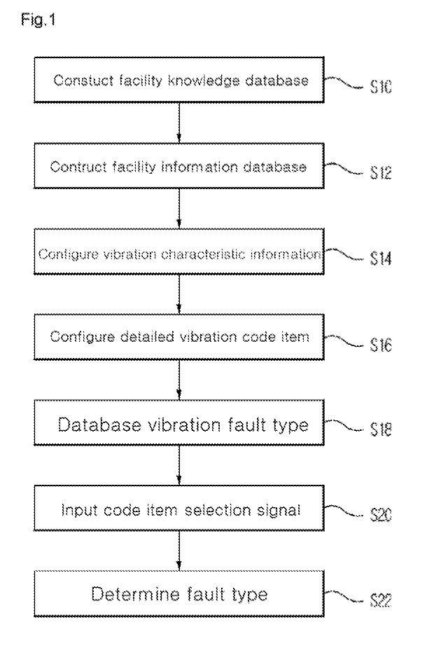

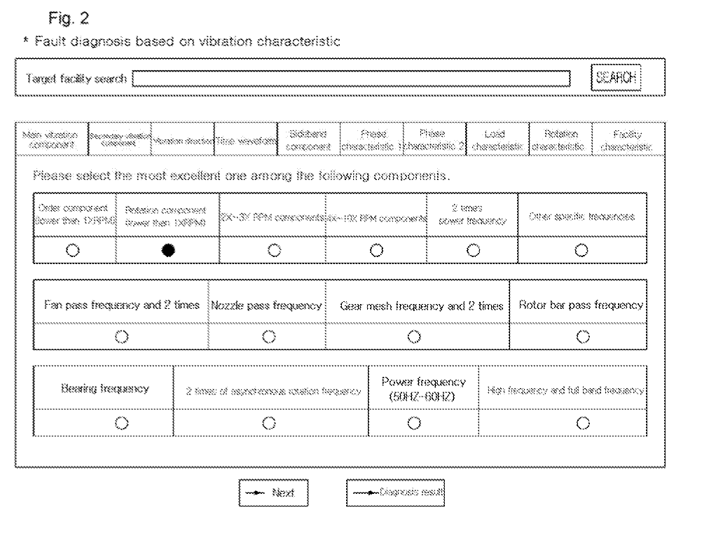

FIG. 1 is a flow chart for describing a method for diagnosing fault of a facilities using a vibration characteristic according to the present invention, and FIGS. 2 to 7 are exemplary views for describing a method for diagnosing fault of a facilities using a vibration characteristic according to the present invention.

The causes for the vibration faults may come from various faults, for example, a fault which occurs at a rotary shaft, a fault due to the loosening of a fixing part, a fault which occurs at a bearing, a fault due to the contact with a shaft, a gear fault, etc. Since the vibration characteristic which may originate from the aforementioned faults may be various, the present invention aims to classify the vibration components which occur due to various faults and then determine the types of vibrations based on the classified vibration components, by which it is possible to enhance the reliability of a vibration fault diagnosis.

Referring to FIG. 1, a facility knowledge database is constructed (S10). The facility knowledge database may contain information on a factory site or a company wherein a facility is installed.

Moreover, a facility information database is constructed (S12). The facility knowledge database may contain information on a site where a facility is installed or various information related with the facility.

The various components related with the faults of each facility are classified, and then the vibration characteristic information are set (S14). In this embodiment of the present invention, the vibration characteristic information may include information on a primary vibration component, a secondary vibration component, a vibration direction, a time waveform, a sideband component, a phase characteristic, a load characteristic and a facility characteristic.

Subsequently, detailed vibration code items with respect to each vibration characteristic information are set (S16). The detailed vibration code items may represent detailed characteristic information on each vibration characteristic. For the detailed vibration code items which may represent main vibration characteristics, the components may be classified into an order component (lower than 1×RPM), a rotation component (1×RPM), 2×-3×RPM components, etc. Since the detailed vibration code items with respect to each vibration characteristic may differ by the type of fault, any fault cause of a facility can be predicted based on a combination of the aforementioned detailed vibration code items. The detailed descriptions on the vibration code items will be described in detail in conjunction with the descriptions on the vibration components by the characteristic of fault which will be described later.

Thereafter, a vibration fault type list is created, and the vibration code items which may be vibration fault causes, may be selected for each vibration fault type and may be combined, thus constructing a database with respect to the vibration fault type information (S18). Only one vibration code item which may be a cause, can be determined for each vibration fault type, but in case of a facility fault, since two vibration code item characteristics may concurrently occur, a priority sequence is assigned in the sequence of vibration code items which have higher possibilities for any item among the vibration code items with respect to each vibration characteristic to be a cause of a corresponding vibration fault type, and then preferably, a related information (a score information based on a priority sequence) between each fault type and vibration code item is databased.

For example, if any fault occurs due to a mass imbalance at a rotary shaft, vibrations may occur at a facility due to the aforementioned fault. The vibration frequency component of this vibration may correspond to a rotation speed of a shaft, and the vibration may occur in the direction of a radius thereof, and a time waveform may be a sine wave. As the rotation speed increases, the vibration of the rotation component may also increase. In case that a phase characteristic is related with a static imbalance, the relative phase angles measured at the bearings at both sides may represent a vibration characteristic related with, for example, the same phase.

The mass imbalance of the rotary shaft in the vibration fault type list is matched with a detailed vibration code item which may be a cause to the mass imbalance of the rotary shaft. If a combination of corresponding vibration code items is detected during the determination of the vibration fault type which will be described later, it can be determined as a mass imbalance fault of the rotary shaft.

Moreover, when the detailed vibration code items of the vibration characteristic which occurs due to the mass imbalance of the rotary shaft are matched, a priority sequence can be assigned with respect to each detailed vibration code item. For example, in case of the mass imbalance of the rotary shaft, if a mass imbalance of the rotary shaft occurs in the direction of vibration, since the main vibration direction is the direction of a radius, the priority sequence is assigned to the radius direction. If the vibration direction corresponds that the radius direction and the axial direction concurrently occur, the sub-priority sequence is assigned. If the vibration direction is the axial direction, the lowest priority sequence is assigned. In this way, the priority sequence can be assigned with respect to the vibration code items for each vibration characteristic with respect to each fault type.

Furthermore, since the levels that the faults are affected for each vibration fault type, are different, the priority sequence can be assigned for each vibration characteristic based on the influence having effect on the fault, and different scores can be assigned for vibration characteristic based on the priority sequence. For example, since the load characteristic is an important item together with the vibration component in terms of an electric fault characteristic, a higher score than the vibration characteristic information may be assigned to the load characteristic.

In a state where the database for each vibration fault type has been constructed, when a user starts a related program so as to diagnose any fault of the facility, the evaluation items are displayed on the screen so that each vibration characteristic and vibration characteristic-based derailed vibration code item selection signal can be received by the user.

Thereafter, the user may obtain a vibration frequency component value measured at an actual facility, and each vibration characteristic-based detailed vibration code item displayed on the menu screen can be selected based on the obtained vibration frequency component (S20).

If the selection with respect to the detailed vibration code items is completed by the user, it is compared to the vibration fault type in the database via a combination of the inputted detailed vibration code items, thus determining a fault type (S22).

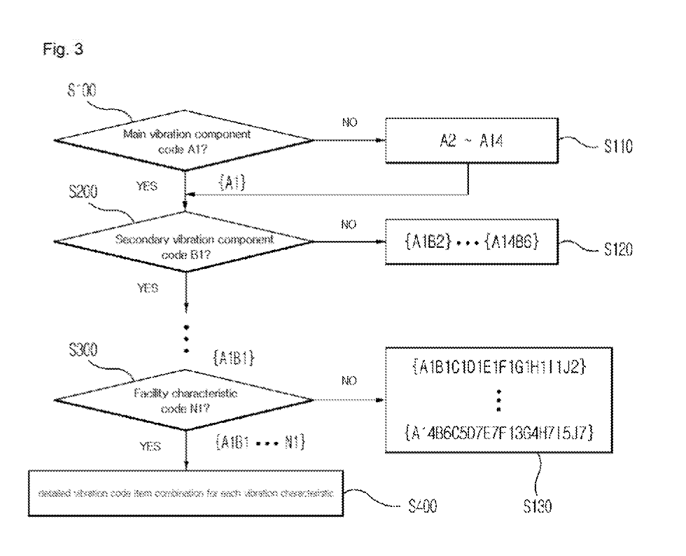

The procedure of the detailed vibration code item combination for determining a vibration type in a method for diagnosing fault of a facilities using a vibration characteristic according to the present invention will be described with reference to FIG. 3.

First, a selected code information is extracted by determining that which item among the detailed vibration code items which have been classified as a main vibration component, has been selected. The detailed vibration codes with respect to the main vibration components may be made as in Table 1. More specifically, it is determined if the detailed vibration code classified as the main vibration component is A1 (S100), and if the selected main vibration component characteristic code is A1, the A1 information is extracted as a combination information, and If not A1, the selected code information is searched from A2 to An (S110).

TABLE 1

| Code No. | A1 | A2 | A3 | A4 | A5 | A6 | A7 |
|---|---|---|---|---|---|---|---|
| Detailed | Lower than | Same | 2-3 times | 4-10 times | 2 times of | Other | 2 times of |
| items | rotation | rotation | of rotation | of rotation | power | specific | fan pass |
| | speed | speed | speed | speed | frequency | frequencies | frequency |
| Code No. | A8 | A9 | A10 | A11 | A12 | A13 | A14 |
| Detailed | Same as | 2 times of | Same as | Bearing | 2 times of | Power | High |
| items | nozzle pass | gear mesh | rotor bar | frequency | asynchronous | frequency | frequency |
| | frequency | frequency | pass | | rotation | | and band |
| | | | frequency | | frequency | | frequency |

Subsequently, if the code extraction with respect to the main vibration component is completed, the selected code information is extracted by determining that which item among the detailed vibration code items classified as a secondary vibration component has been selected. In this case, the aforementioned procedure may be carried out in the same way as in the main vibration component code information extraction. In addition to that, all the detailed vibration code information selected for each the remaining vibration characteristic are extracted, and the finally extracted detailed vibration codes are combined. If the detailed vibration codes which have been extracted in this way, are combined, it is possible to obtain any code combination from {A1B1 . . . N1} to {An, B, . . . Nn}.

The detailed item code information with respect to the secondary vibration component may be classified into a low frequency band, a high frequency band, a rotation component, a sum of an order component and a multiple component, an asynchronous rotation component, etc.

Moreover, the vibration direction may be classified into a radius direction, an axial direction, a radius and axial direction, an orientation vibration (a vertical to horizontal direction, a horizontal to vertical direction), etc.

Furthermore, the time waveform may be classified into a since waveform, a shock waveform, a modulation waveform, an asymmetric waveform, a disconnection waveform, a discontinuous waveform, etc.

In addition, the sideband component may be classified into a differential component (a component lower than a rotation speed), an asynchronous component, a component which is 2˜3 times of a rotation speed, a pole number X-slip frequency, a power and 2-multiple power frequency, a no-sideband, etc.

Moreover, the phase characteristic may be classified into a rotary shaft with respect to an in/out board, a radius direction of a rotary shaft, a direction information of a phase with respect to a coupling unit, a phase change state, etc.

Moreover, the load characteristic may be classified into a vibration increase during a connection, a periodic vibration, and a fast vibration increase during a load increase, and the rotation characteristic may be classified into a vibration increase during a rotation increase, a fast increase based on a revolution, and a decrease after a vibration increase, and the power characteristic may be classified into a vibration extinction when blocking a power, a vibration remain when blocking a power, etc.

Furthermore, the facility characteristic may be classified into a rolling bearing and a sliding bearing in terms of the type of a bearing, and a direct driving, a belt driving, a fluid coupling and an overhung type in terms of a connection method type.

If any result of the detailed vibration code combination is obtained, each vibration fault type-based vibration fault evaluation score of a vibration fault type list set in the database is calculated, and a vibration fault evaluation score ranking is selected, and a vibration fault having the highest evaluation score may be determined as a main vibration fault. In the calculation of the vibration fault evaluation score, the scores are assigned for each detailed vibration code item information based on the priority sequence information of each detailed vibration code information selected by the user with respect to one fault type. If the scores of all the vibration code information are combined, a score with respect to a corresponding fault type can be calculated. The score with respect to all the fault types can be calculated by repeating this procedure with respect to all the fault types.

The exemplary fault calculation procedure will be described. First, an occasion wherein the vibration fault type set in the database corresponds to a mass imbalance of a rotary shaft, a bent shaft vibration fault, and a distortion, and the vibration code combination selected by the user is A1, B1, . . . , N1 will be described. Assuming that there are A1, B2, and Nn as the detailed vibration code which may be a cause of the mass imbalance vibration fault of the rotary shaft, and the priority sequence with respect to the A1 code is higher in the mass imbalance vibration fault of the rotary shaft, the code item selected by the user contains A1, so the score assigned to A1 may be added to the evaluation score. Here, since the priority sequence of A1 in the mass imbalance vibration fault of the rotary shaft is high, the evaluation score may be calculated with the value which has contributed to assigning a high score to A1. Moreover, the scores can be calculated with respect to the remaining code items in such a way to match the code items set in the database and the thusly assigned value. If the vibration fault evaluation score calculation is completed with respect to the mass imbalance of the rotary shaft, a score calculation with respect to a bent shaft vibration fault, a distortion, etc. will be sequentially carried out.

When determining the vibration fault type, the evaluation scores may be differentiated in such a way that a predetermined weight is provided to a fault type which may contain a lot of the top priority sequence vibration code items set for a corresponding vibration fault type among the detailed vibration code items selected by the user with respect to the vibration fault types having the same vibration evaluation scores.

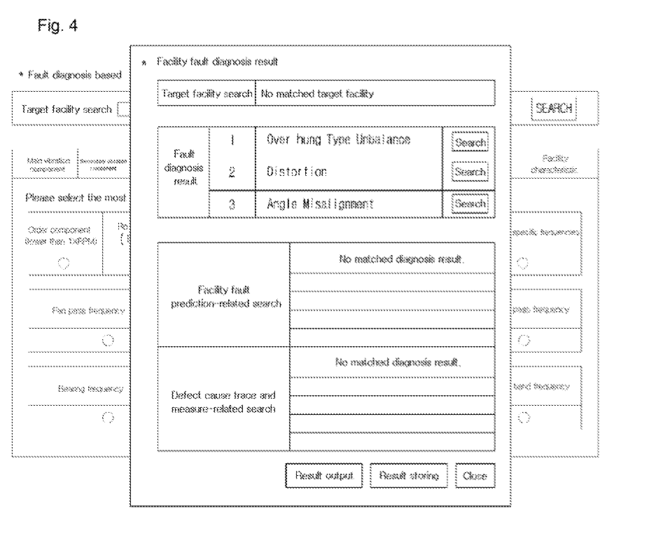

Meanwhile, if the all the evaluations are completed, a result of the evaluations is displayed on the screen as in FIG. 4 for the user to confirm a result of the evaluation, and it can be stored to use as a history information with respect to the facility. Here, in a result of the evaluation, the vibration fault type corresponding to the highest evaluation score may be first displayed by determining it as a main fault, and the faults corresponding to the next highest evaluation cores are displayed up to the sequence set in the ranking of evaluation scores.

The detailed descriptions on the vibration frequency component, namely, the detailed vibration code items, which may be the causes of various vibrations, and the principles which should be considered when diagnosing the faults will be described below.

1. Fault which may occur at a rotary shaft.

1) A mass imbalance of a rotary shaft (a mass imbalance of a rotary shaft)

The rotational machine is configured to generate a driving force as a rotary shaft supported by bearings rotates. During the manufacturing of a rotation body, if the rotation center of the rotation body and the gravity center of the rotation body mismatch due to an assembling accuracy fault, a contact with a rotation body during the operation, and a separation of a predetermined component, a mass imbalance may occur. If the rotation body continues to operate in an imbalance state, a centrifugal force may cause a swiveling motion out of the center due to the mass which has been concentrated at one side, and an over load and stress may occur at the bearing which is supporting the shaft, thus causing a fault. At this time, the level of the fault may be in proportion to the magnitude of the deviated mass and the rotation speed, and a static imbalance, a dynamic imbalance and a couple force imbalance may occur based on the position of the deviated mass. The characteristics of the vibration which may occur due to the fault are as follow.

A) The vibration frequency component corresponds to a rotation speed of a shaft.

B) The vibration may generate in the radius direction.

C) The time waveform is a sine waveform.

D) As the rotation speed increases, the vibration of the rotation component increases.

E) In the phase characteristics, the relative phase angle measured at both the bearings are the same phase in case of the static imbalance, and the couple force imbalance shows that the relative phase angle is opposite (180°), and the dynamic imbalance shows a phase difference based on the angle where two masses are located.

In the facility diagnosis method, the aforementioned vibration characteristics are first recognized, and it is confirmed if the aforementioned characteristics have shown at the rotation machine which is in operation, thus determining if a fault has occurred at the rotation machine.

2) An alignment fault at a rotary shaft.

The axial alignment at the rotary shaft may represent that the rotation centers of driving shaft and a driven shaft are coincided and made parallel to each other. For this, there may be two ways wherein the positions of the bearings of two shafts are adjusted and coincided, and the shafts don't have any eccentric center and eccentric angle when coupling the two shafts to the coupling. The shaft alignment fault may occur if a shaft connection condition is not satisfied, and when the centers of the shafts are not coincided, it is called an eccentric alignment fault, and if the centers of the shafts are coincided, but not parallel, it is called an eccentric angle alignment fault.

At this time, since the rotary shaft is forcibly bent, vibrations may occur, while causing an abrasion and a fault at the shaft, the bearing and the coupling. The characteristics of the vibrations which may occur due to the aforementioned fault are as follows.

1) An eccentric alignment fault.

A) The vibration frequency component is a component which is 2 or 3 times of the shaft rotation speed.

B) The vibration direction is a radius direction.

C) The time waveform of the vibration signal is a sine waveform.

D) It is not greatly affected by the rotation speed.

E) In the phase characteristic, the phase difference measured in the radius directions of both the bearing housings disposed about the coupling has an opposite (180°) phase.

2) An eccentric angle alignment fault.

A) In the vibration frequency component, a 1-time component of the shaft rotation speed is highest.

B) The vibration direction is defined in the shaft direction.

C) The time waveform of the vibration signal is a sine waveform.

D) It is not greatly affected by the rotation speed.

E) In the phase characteristic, the phase difference measured in the axial directions of both the bearing housings disposed about the coupling has an opposite (180°) phase.

As the fault related with the rotary shaft, there are a bending fault of the shaft, a crack which occurs at the shaft, a resonance of the rotation body. The characteristic of the vibration related with the aforementioned faults is as follows.

3) The characteristic of the vibration which occurs due to the bending fault of the shaft.

A) The vibration frequency component is a rotation speed of the shaft.

B) The vibration direction is defined in the radius direction and the axial direction.

C) The time waveform is a sine waveform.

D) As the rotation speed increases, the vibration of the rotation component increases.

E) The phase difference in the radius direction has the same phase (0°) at both the bearings, and the axial direction phase has the opposite phase (180°).

4) The characteristic of the vibration which occurs due to the crack at the shaft.

A) The vibration frequency component is a rotational speed of the shaft.

B) The vibration direction is defined in the radius direction.

C) The time waveform is a sine waveform.

D) As the operation speed or the operation time passes, the vibration amount changes.

E) The phase measured at the bearing housing changes as the operation time passes.

5) The characteristic of the vibration which occurs due to the resonance of the rotary shaft.

A) The vibration frequency component corresponds to a frequency wherein the rotation speed of the shaft coincides with the number of natural vibrations of the shaft.

B) The vibration direction is a radius direction. If resonance occurs at a support member which is supporting the shaft, the resonance will also occur in the direction of the shaft.

C) The time waveform is a sine waveform.

D) if the rotation speed is out of the number of natural frequency of the shaft, the vibration can be greatly decreased.

E) The phase will change 180° before and after the resonance.

2. The fault due to the loosening of the fixing part.

The fault may occur if the loosening occurs between the bolt fixing parts, for example, the engaging part between the components belonging to the rotation body or a temporal support member or a loosening fault occurs. The occurrence of the vibration may cause a hit once per rotation of the loosened machine component, thus causing a rotation frequency component vibration, and the vibration of multiple components may occur due to a nonlinear response of the loosened component with respect to the dynamic pressure of the rotation body.

A) The vibration frequency component may cause a harmonic wave component including a rotation.

B) If the fixing bolt part is loosened, the vibration waveform may become a disconnection waveform, and if the loosening occurs at the rotation element, such as, a coupling, etc., the shock waveform may generate at every one rotation.

C) The vibration direction may be a radius direction, but if the loosening occurs at the fixed part of the horizontally disposed machine, the vibration may more increase in the vertical direction.

D) If the loosening occurs at the rotation element, the vibration frequency may have a high frequency component.

E) If the loosening occurs at the rotation element, the phase may show an unstable state, and if the loosening occurs at the fixed part, a 180° phase difference may occur between the fixed part and the temporal member of the rotational machine.

3. A fault at the bearing.

The bearing is a very important element at a machine which does not transfer the rotation speed of the rotation body to the outside of the bearing, while restricting the dynamic movement which occurs by the rotary shaft to the radius direction or the axial direction and supporting the weight of the rotation body. The bearing may be classified based on the fact that it has a rolling function or not. If the bearing has a rolling function, it is called a rolling bearing, and if not any rolling function, it is called a sliding bearing.

The bearing is an important element which has direct effect on the performance and service life of the rotational machine. If the rotary shaft rotates, vibration always occurs. The present invention is directed to a method for diagnosing any fault at the bearing which may cause a defect due to an abnormal vibration. Since even small fault at the bearing may have effect on a stable operation of the whole rotational machine, it needs to detect such a fault as soon as possible, and a proper quick measure is necessary to prevent any possible degradation at the bearing.

1) A vibration which occurs due to a rolling bearing fault.

The rolling bearing is formed of a power-driven body which is a rolling element, and a cage configured to cover an inner race, an outer race and the electric body. Vibration may occur since the power-driven body contacts with an orbital surface and the cage. The fault frequencies may generate all different based on the position where the fault exists. More specifically, if the power-driven body has any fault, for example, at the fault frequency of the power-driven body or the inner race, it may be classified as an inner race fault frequency. A facility operator is able to recognize the position of the fault at the bearing in such a way to measure the vibration at a bearing portion and analyze the generating vibration frequency.

A) A vibration fault frequency.

If the rotary shaft is rotating contacting with the inner race, namely, if the inner race is rotating at a rotation speed of the shaft, the fault frequency generating at each portion of the bearing may be expressed as in Formulas 1 to 4.

If the outer race has a fault, the following formula 1 may be employed.

$${P}_{0} = \frac{NB \times RPS}{2} \times ( 1 - \frac{BD}{PD} cos θ ) \qquad [ Formula 1 ]$$

If the inner race has a fault, the following formula 2 may be employed.

$${P}_{1} = \frac{NB \times RPS}{2} \times ( 1 + \frac{BD}{PD} cos θ ) \qquad [ Formula 2 ]$$

If the power-driven body has a fault, the following formula 3 may be employed.

$${P}_{B} = \frac{1}{2} \times \frac{PD}{BD} \times rps \times [ 1 - {( \frac{BD}{PD} )}^{2} {( cos θ )}^{2} ] \qquad [ Formula 3 ]$$

If the cage has a fault, the following formula 4 may be employed.

$${P}_{C} = \frac{1}{2} \times rps \times C ( 1 - \frac{BD}{PD} cos θ ) \qquad [ Formula 4 ]$$

wherein NB means the number of balls, and rps means the revolution (HZ) of the rotary shaft, Pd means a pitch diameter of the bearing, and Bd means the diameter of a bearing ball, and θ means an angle that the power-driven body contacts with the outer race.

B) The vibration direction may be defined in the radius direction, and in case of an angular contact bearing, the vibration occurs in the axial direction.

C) The time waveform may be formed in a shock waveform at a fault frequency interval.

D) In the vibration frequency spectrum, the fault frequency has a wide bandwidth.

E) The cage fault frequency, in general, has a sideband form accompanied with other fault frequencies.

F) If the degradation of the bearing continues long, the rotation frequency of the rotary shaft may have a sideband form of the fault frequency.

2) A vibration which occurs due to a sliding bearing fault.

Since the sliding bearing is able to support the weight while reducing any friction with the aid of a thin oil film between the surface of the rotation body and the bearing metal, if a friction occurs at the metal or a gap of the bearing is large, a nonlinear vibration having a frequency component may occur at 0.42˜0.48 times of the revolution. This vibration may occur in a circumferential direction of the rotary shaft, and at below 2 times of the risk speed of the shaft, an oil whirl vibration may occur, wherein the shaft swivels in a rigid body state, and if it reach 2 times of the risk speed, an oil whip may occur, wherein it may be referred to an unstable vibration of a self-swivel state, whereupon the bearing as well as the rotation body may be damaged, which may result in the damage to the machine. To this end, a predetermined method is necessary, which is able to previously detect any fault frequency and take a measure.

If the oil whirl and the oil whip occur, the vibration characteristics are as follows.

A) The vibration frequency component may generate at about ½ times of the rotation speed of the rotary shaft.

B) If the rotation speed of the shaft reaches 2 times of the primary risk speed of the rotation body, the amplitude may suddenly increase due to the self-induced vibration, and once such a situation takes place, it won't decrease even though the speed is increased, while continuously maintaining the same.

C) The swiveling direction of the vibration is same as the rotation direction of the shaft, and the vibration may occur in the radius direction.

D) If the oil whip occurs, the phase of the vibration may change.

4. A fault due to a contact with a shaft.

If a fault occurs, wherein the rotary shaft contacts with a fixed object, a contact fault vibration may occur, and in case where a contact is made at a sliding bearing, the bearing may be damaged, and if such a fault continues, the rotational machine may have a critical defect. The fault vibration frequency may generate different based on the type of contacts.

1) A bending vibration due to a contact heat.

If the rotary shaft has a tiny contact near the bearing, heat may generate due to the contact, which may lead to the bending of the shaft, whereupon a vibration similar to an imbalance vibration may occur.

A) The vibration frequency component is a rotation speed of the shaft.

B) The vibration may occur in the radius direction.

C) The vibration amplitude may increase based on the bending degree.

D) The time waveform is a sine waveform.

E) The phase may change as the operation time passes.

F) The fault frequency does not generate at the beginning of vibration or if the contact is not made.

2) A hit and bounce vibration.

If a contact occurs like a hit between a rotation body having a large diameter and a stopping part, the fault frequency component same as the rotation speed component occurs, and if a hitting magnitude is high, the natural vibration number component of the rotation body or the fixed part may be excited, whereupon a high amplitude vibration may occur near the natural vibration number.

A) The vibration frequency component corresponds to the rotation speed of the shaft.

B) The direction wherein the vibration occurs refers to the radius direction,

C) The time waveform may be shown in the form of a shock waveform per revolution.

D) The vibration amplitude may increase near a natural vibration number.

E) Whenever the contact vibration occurs, the phase changes.

3) A contact self-excitation vibration.

If a contact is made between the rotation body and the stopping part, and a friction coefficient is high, a vibration may occur, wherein the rotation body swivels backward within the gap. If this vibration frequency matches with the natural vibration number, a vibration with a high amplitude may generate. If the conditions of the gap between the rotation body and the stopping part, the revolution and an attenuation ratio match with the condition causing a self-excitation vibration, a self-excitation vibration having a high amplitude may generate.

A) The vibration frequency number component may cause a fractional harmonic wave component may generate together with a rotation speed component of the shaft.

B) The direction where the vibration occurs is referred to the radius direction.

C) The time waveform has a configuration wherein one side is disconnected or formed flat.

D) The friction and hit may excite the natural vibration number of the rotation body or the fixed part, so a high amplitude vibration may occur near the natural vibration number.

E) The phase may have a predetermined change during operation.

5. A gear fault.

The gear device is a driving force transfer device which is able to accelerate or decelerate the rotation speed of the driving shaft and is a machine device which in general is used to randomly change the directions of an input shaft and an output shaft. In recent years, as a gear device is able to withstand a high load and operate at a high speed, if any fault occurs, a degradation due to fatigue may proceed fast, and a critical defect, for example, an abrasion, a fracture, etc. may occur.

The gear device is configured complicated with a plurality of gears and is installed housed in a thick case. For this reason, it is very hard to detect any fault at an initial stage. A facility operator may be able to find out any fault in such a way to accurately measure a fault frequency number which occurs at the gear device and carry out a precise accurate vibration analysis.

1) A fault due to a gear precision defect.

If a gear has an eccentricity, a pitch defect, a tooth form defect or a damage to a tooth surface, a transfer weight in a circumferential direction may occur, and a dynamic weight which generates due to a tooth form defect, etc. may be forcibly excite the gear. The fault vibration frequency which generates in the aforementioned situation, is as follows.

A) The vibration frequency component is a gear mesh frequency component.

The mesh frequency may be defined by the following formula 5.

GMF=Nt×rps [Formula 5]

wherein Nt means the number of gear teeth, and rps means the revolution of the gear shaft.

B) The vibration may generate in the radius direction, and in case of a helical gear, the vibration may generate in the axial direction.

C) If the gear has eccentricity, the rotational component of the rotary shaft may occur at left and right sides of the gear mesh frequency in the form of sidebands.

D) If there is a pitch defect, a plurality of rotational components may occur at left and right sides of the gear mesh frequency in the form of sidebands.

E) If a fault, for example, a damage to a gear tooth surface occurs at the surface of the gear, a gear mesh frequency component as well as second and third harmonic components generate together.

F) The time waveform of the vibration signal is a modulation waveform.

2) A fault due to a defect at a gear shaft.

If an alignment defect occurs at a gear shaft when installing the gear, the gear may have an eccentric contact, and a hit force may generate when the gears are engaged, thus exciting the gear. Since the vibrations in the radius direction and axial direction of the gear may generate concurrently in the form of the bearing housing bending vibrations, it may cause a big damage to the bearing.

A) The vibration frequency component is a gear mesh frequency component.

B) The rotational component may generate at left and right sides of the gear mesh frequency in the form of sidebands.

C) The gear mesh frequency and the second and third harmonic components may generate. The amplitude of the primary gear mesh frequency component is mainly high.

D) The time waveform of the vibration signal is a modulation waveform.

3) A fault due to a damaged gear tooth.

If any gear tooth is damaged, a shock wave may generate once per revolution of the gear having the damaged tooth, so it is effective to search for this waveform from the time waveform.

A) The vibration frequency component may have both the gear mesh frequency component and the shaft rotation frequency component of the shaft having the damaged tooth.

C) The sideband of the rotation component may generate at left and right sides of the gear mesh frequency.

In the time waveform of the vibration signal, a shock wave may generate once per revolution of the rotary shaft having the damaged tooth.

A fault due to a defect combination in the number of gear teeth.

Two engaging gears have their own numbers of teeth. If a combination defect occurs in the numbers of their teeth, a fault may occur, and a service life of each gear may decrease. If the greatest common divisor is 1 after the numbers of teeth of two gears are factorized in prime factors, the driving gear may be engaged with the whole teeth of the driven gear before the driving gear has been first engaged with the teeth of the driven gear, and then have been engaged with the same teeth. If the greatest common divisor is larger than 1, only a few teeth are engaged often.

If one tooth surface of the driving gear has a defect in the tooth form thereof, only a few teeth of the driven gear engaged often with the aforementioned teeth may be damaged, so the service life of the gear may be decreased. The fault vibration frequency which generates at this time, may cause a fractional gear engagement frequency of a high amplitude together with the gear engagement frequency.

A) The vibration frequency component is a fractional engagement frequency component of the greatest common divisor with respect to the gear engagement frequency component.

B) The amplitude of the fractional engagement frequency component is larger than the gear engagement frequency component.

C) The vibration direction is a radius direction.

6. A motor fault.

An induction motor is being widely at an industrial site as a device for generating a driving force. The induction motor has an advantage in the way that it has a simpler configuration as compared to a rotational machine such as a turbine, a compressor, etc., and faults don't generate a lot, but an electrical and mechanical defect may occur between the rotor and the stator which are important components, thus causing a problem.

1) An aperture imbalance.

If a size imbalance occurs at an aperture between the rotor and the stator, an imbalance magnetic suction force may generate between the rotor and the stator. The rotor and the stator may vibrate together with the rotation of a spinning magnetic field, and the rotary shaft may generate vibrations which are 2 times of the power frequency.

If the stator has an eccentricity, it is called a static electricity. The eccentric stator may cause an uneven aperture between the stator and the rotor. Consequently, 2 times component of the power frequency may generate, and it may have a large orientation. This may be caused due to a stator which has manufactured wrong, an incorrect lamination structure, a foundation of a bent motor, and a soft foot.

If the rotor has an eccentricity, it is called a dynamic eccentricity. The eccentric rotor may cause an imbalance magnetic suction force between the apertures. The vibration frequency component which generates due to the aforementioned defect, may have “the number of poles×slip frequency” in the form of a side band at the left and right sides of each of the rotation component of the rotary shaft, 2 times component of the power frequency, and 2 times component of the power frequency.

An imbalance at the windings of the stator and the rotor.

If an imbalance exists at the winding of the stator, an imbalance magnetic suction force may generate, and 2 times component of the power frequency may generate in the circumferential direction. If an imbalance exists at the winding of the rotor or a defect, for example, a breakage, etc. occurs at a rotor bar, a sideband of “the number of poles×slip frequency” may generate at left and right sides of the rotation speed component, and a sideband component of “the number of poles×slip frequency” may generate at left and right sides of 2 times power frequency. If the defects and the breakage of the bar of the rotor generate lots, a high amplitude of the sideband may generate. If any degradation occurs at the winding of the stator, together with 2 times component of the power frequency, the component of the rotor bar pass frequency and 2 times of the power frequency may occur at left and right sides.

3) An imbalance at a power voltage.

If an imbalance exists at a power voltage, a torque which may apply to the rotor, may generate, and a torque pulsation may generate at the stator as a reaction in response to the torque. In the stator, a power frequency multiple component may generate in the radius direction due to the torque pulsation, and 2 times component of the power frequency may have the highest amplitude. The vibration having a rotation speed component may generate at a rotation shafting. The fault vibration components due to electrical faults may be collectively summarized as follows.

TABLE

| Type of faults | Fault vibration frequency | Remarks |
|---|---|---|
| Power voltage imbalance | 1X, f_{L}, 2f_{L}, 3f_{L}, 4f_{L} | As for the electrical fault, if the power |
| Loosening at connector part | 1X, f_{L}, 2f_{L}, 3f_{L}, 4f_{L} | supplied to the motor is disconnected, |
| Imbalance at the winding of a stator | 2f_{L} | the vibrations stop instantly. The |
| Imbalance at the winding of a rotor | 1X, 2f_{L}, 2f_{L±} PxSF | vibration of the rotation speed, |
| Degradation at the winding of a stator | 2f_{L}, RBPF_{±}2f_{L} | however, does not stop instantly even |
| Imbalance at an aperture due to the | 2f_{L} | if the power is disconnected. |
| eccentricity of a stator | | |
| Imbalance at an aperture due to the | 1X, 2f_{L}, 2f_{L±}PxSF | |
| eccentricity of a rotor | | |
| Loosening of a core of a stator | 1X, 2X, 2f_{L} | |

where 1× means the rotation speed component of the rotor, and f_{L} means the power frequency component.

P: The number of poles, SF: Slip frequency

RBPF: Rotor bar pass frequency (RBPF=NRB×rps)

NRB: The number of rotor bars, rps: Rotation speed of rotor

### INDUSTRIAL APPLICABILITY

The present invention is an invention which can be usefully employed for a plant facility or at a manufacturing site since fault of a facilities can be predicted by inputting only a vibration state of the facility without any professional knowledge on the facility.

1. A method for diagnosing fault of a facilities using a vibration characteristic, comprising:
a step wherein the vibrations occurring due to fault of a facilities are classified into a plurality of vibration characteristics, and the vibration characteristics are classified in detail, thus setting detailed vibration code items, and the detailed vibration code items are related for each fault item and are stored in a database;
a step wherein a detailed vibration code item selection signal is received for each vibration characteristic from a user, and
a step wherein a fault type of the facility is determined based on a related information between each inputted detailed vibration code item, the fault type and the detailed vibration code item.

2. The method of claim 1, wherein the vibration characteristic information include two or more of a main vibration component, a secondary vibration component, a vibration direction, a time waveform, a sideband component, a phase characteristic, a load characteristic and a facility characteristic.

3. The method of claim 1, wherein in the step wherein the database is constructed by relating the detailed vibration code item with each fault type, a priority sequence is assigned for each detailed vibration code item based on the extent where the vibration fault is affected for each fault type, and scores are differentiated based on the priority sequence.

4. The method of claim 3, wherein in the step wherein the vibration fault types are databased, a priority sequence is assigned for each vibration characteristic information based on the extent where the vibration fault is affected for each vibration fault type, and scores are differentiated based on the priority sequence.

5. The method of claim 3, wherein in the step wherein the fault type of the facility is determined, a vibration fault evaluation score is calculated based on an information on which at least one or more of a priority sequence with respect to a detailed vibration code item selected by a user for each vibration fault type set in the database or a priority sequence for each vibration characteristic Information has been reflected, and a vibration fault type is determined based on the calculated vibration fault evaluation score.

6. The method of claim 5, wherein if the vibration evaluation scores for each vibration fault type are same, a weight is assigned to a vibration fault type having more detailed vibration code items set in the top priority sequence for each vibration fault type among the detailed vibration code items selected by the user, and the vibration types having the same vibration evaluation scores are differentiated.

7. The method of claim 6, wherein the sequence-based vibration fault types prepared up to the previously set ranking are provided for the user to confirm.
